(19) United States
(12) Patent Application Publication
(10) Pub. No.: US 2013/0179937 A1
(43) Pub. Date: Jul. 11, 2013

(54) SECURITY MODEL ANALYSIS

(71) Applicants: Marco Casassa Mont, Bristol (GB); Richard Brown, Bristol (GB); William G. Horne, Lawrenceville, NJ (US); Siva Raj Rajagopalan, Morris Plains, NJ (US); Prasad V. Rao, Metuchen, NJ (US)

(72) Inventors: Marco Casassa Mont, Bristol (GB); Richard Brown, Bristol (GB); William G. Horne, Lawrenceville, NJ (US); Siva Raj Rajagopalan, Morris Plains, NJ (US); Prasad V. Rao, Metuchen, NJ (US)

(21) Appl. No.: 13/347,098

(22) Filed: Jan. 10, 2012

(51) Int. Cl. G06F 21/00

(52) U.S. Cl. 726/1

(57) ABSTRACT

A customized security model template is created that is customized for a specific organization's security related procedures. The customized security model template is instantiated with parameters associated with the organization to create an instantiated security model, and a report is produced based on simulations of the instantiated security model that specifies metrics of the organization's security implementation.

### BACKGROUND

Members of organizations who are in charge of making security related decisions often have limited resources with which to work. For example, a chief information security officer may have to make decisions as to what security policies and procedures most effectively provide security defenses for an organization. It is often difficult for this decision maker to determine how well a particular investment into a particular security measure will affect the current system of measures.

### BRIEF DESCRIPTION OF THE DRAWINGS

The accompanying drawings illustrate various examples of the principles described herein and are a part of the specification. The drawings are merely examples and do not limit the scope of the claims.

FIG. 1 is a diagram showing an illustrative physical computing system, according to one example of principles described herein.

FIG. 2 is a diagram showing an illustrative process for analyzing security policies and procedures, according to one example of principles described herein.

FIG. 3 is a diagram showing an illustrative general security model template, according to one example of principles described herein.

FIG. 4A is a diagram showing an illustrative customized alert block of a customized security model template, according to one example of principles described herein.

FIG. 4B is a diagram showing an illustrative customized triage block of a customized security model template, according to one example of principles described herein.

FIG. 5A is a diagram showing an illustrative false positive block of a customized security model template, according to one example of principles described herein.

FIG. 5B is a diagram showing an illustrative instantiated false positive block of a customized security model template, according to one example of principles described herein.

FIG. 6 is a diagram showing an illustrative graph resulting from simulations run from an instantiated security model, according to one example of principles described herein.

FIGS. 7A and 7B are graphs showing results of simulations run from an instantiated security model with varying parameters, according to one example of principles described herein.

FIG. 8 is a flowchart showing an illustrative method for analyzing security policies and procedures, according to one example of principles described herein.

Throughout the drawings, identical reference numbers may designate similar, but not necessarily identical, elements.

### DETAILED DESCRIPTION

As mentioned above, members of organizations who are in charge of making security related decisions for information technology systems often have limited resources with which to work. It is often difficult for this decision maker to determine how well a particular investment into a particular security measure will affect the current system of measures. Specifically, it is often difficult to determine how particular changes in policy or procedure will affect the incident management and remediation parameters of a security team's operations.

In light of this and other issues, the present specification discloses techniques for security system modeling that may provide decision makers with useful information regarding an information technology security team's effectiveness. This information may include assessments of current security risks and security team performances. The information may also include projections based on hypothetical situations.

According to certain illustrative examples, a general security model template is used to create a customized security model template. The general security model template is a broad model that may apply to general security procedures but is not specific to any organization's security related actions. The customized security model template is specifically tailored to a particular organization. This tailoring includes incorporating the policies and procedures relating to security issues such as remediation and incident management actions that are taken based on certain alerts received from security team personnel.

Security personnel typically handle events and alerts flagged by a security system. For example, a security system may be designed to flag certain types of network activity for review by a member of a security team. These security team members must sift through these alerts to determine which ones represent a significant enough threat to warrant remedial action. This process often involves certain policies for handling known and unknown threats. A certain number of events and alerts are false positives and thus represent no significant threat. Time spent on such false positives wastes the time of security team personnel and thus it is desirable to minimize time spent on false positives.

Furthermore, once certain events or alerts are determined to indicate an actual threat, there are a number of procedures which are executed to protect the organization from this threat. This may involve shutting down certain systems to prevent access while the system is vulnerable, deploying additional controls, and increasing the amount of monitoring on a system. Additional processes are executed to remove the threat so the system can return to normal operating conditions. Various policies and procedures are put into place to effectively handle the remediation efforts.

The customized security model template embodying principles described herein is derived from a general security model template. For example, the general security model template may include the basic steps of alert reception, triage, additional analysis, handling false positives, incident management efforts, and remediation efforts. Different organizations may have different methods of handling such general processes and thus the customized security model template embodies the approach of the organization to which it is tailored.

The customized security model template is then instantiated with parameters for the organization to which it is tailored. These parameters may include empirical data such as historical information about the average number of alerts or events received. Additionally, the historical information may relate to the average time it takes security personnel to complete specific tasks. The parameters may also include various assumptions and projections such as how many alerts are expected to be handled at a future time or in case of an extreme incident. Various security simulations may then be run based on the instantiated customized security model to produce reports indicating the effectiveness of the current procedures. These reports may be compared to other reports run on different instantiations with varying parameters to determine the effectiveness of different policies. By using such tools, decision makers are provided with better information related to how best to maximize security efficiency with limited resources.

In the following description, for purposes of explanation, numerous specific details are set forth in order to provide a thorough understanding of the present apparatus, systems and methods. It will be apparent, however, to one skilled in the art that the present apparatus, systems and methods may be practiced without these specific details. Reference in the specification to “an example” or similar language means that a particular feature, structure, or characteristic described in connection with that example is included as described, but may not be included in other examples.

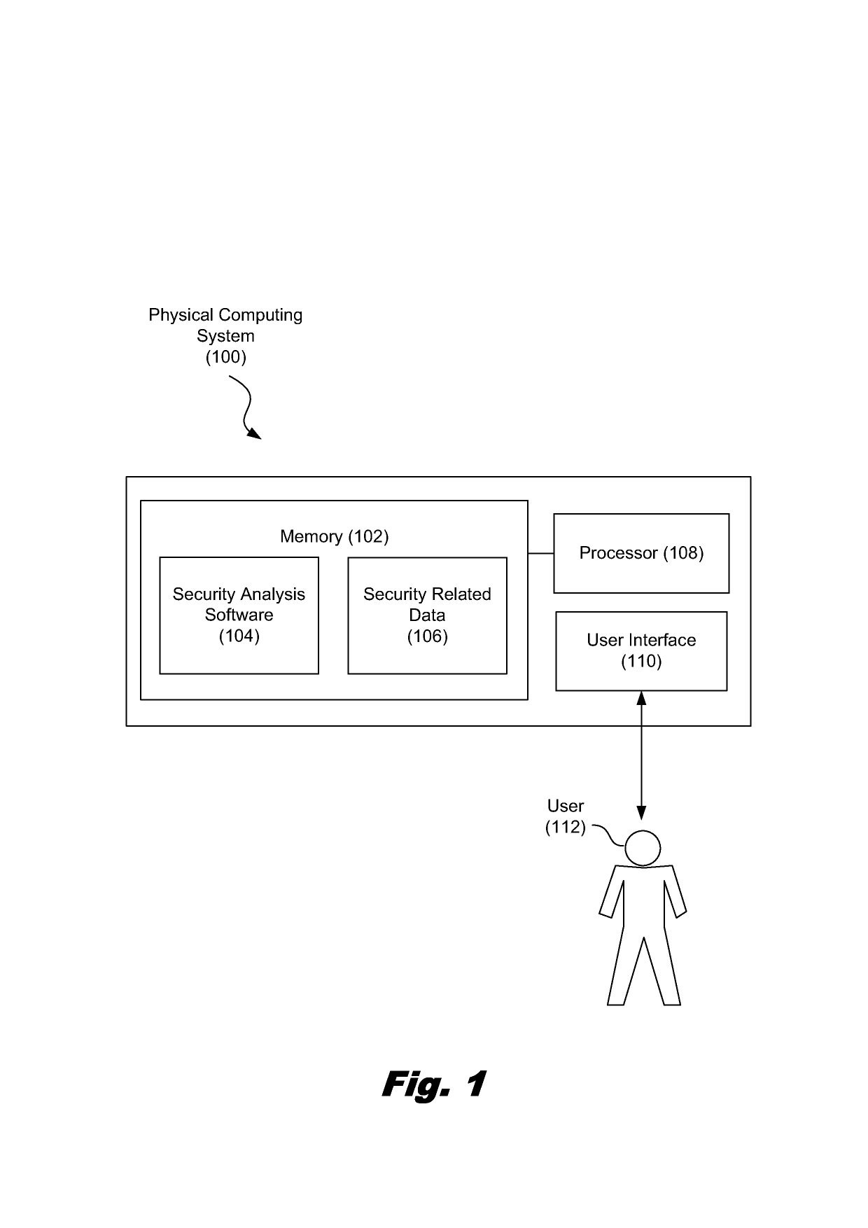

Referring now to the figures, FIG. 1 is a diagram showing an illustrative physical computing system (100) that maybe used for security related decision support. According to certain illustrative examples, the physical computing system (100) includes a memory (102) having security analysis software (104) and security related data (106) stored thereon. The physical computing system (100) also includes a processor (108) and a user interface (110).

There are many types of memory available. Some types of memory, such as solid state drives, are designed for storage. These types of memory typically have large storage volume but relatively slow performance. Other types of memory, such as those used for Random Access Memory (RAM), are optimized for speed and are often referred to as “working memory.” The various forms of memory may store information in the form of software (104) and data (106).

The physical computing system (100) also includes a processor (108) for executing the software (104) and using or updating the data (106) stored in memory (102). The software may include an operating system. An operating system allows other applications to interact properly with the hardware of the physical computing system. Such other applications may include decision support applications such as a piece of security analysis software (104) that simulate outcomes of security procedures based on security models. As will be described in further detail below, the security analysis software (104) may utilize security related data (106) such as historical data.

A user interface (110) may provide a means for the user (112) to interact with the physical computing system (100). The user interface may include any collection of devices for interfacing with a human user (112). For example, the user interface (110) may include an input device such as a keyboard or mouse and an output device such as a monitor.

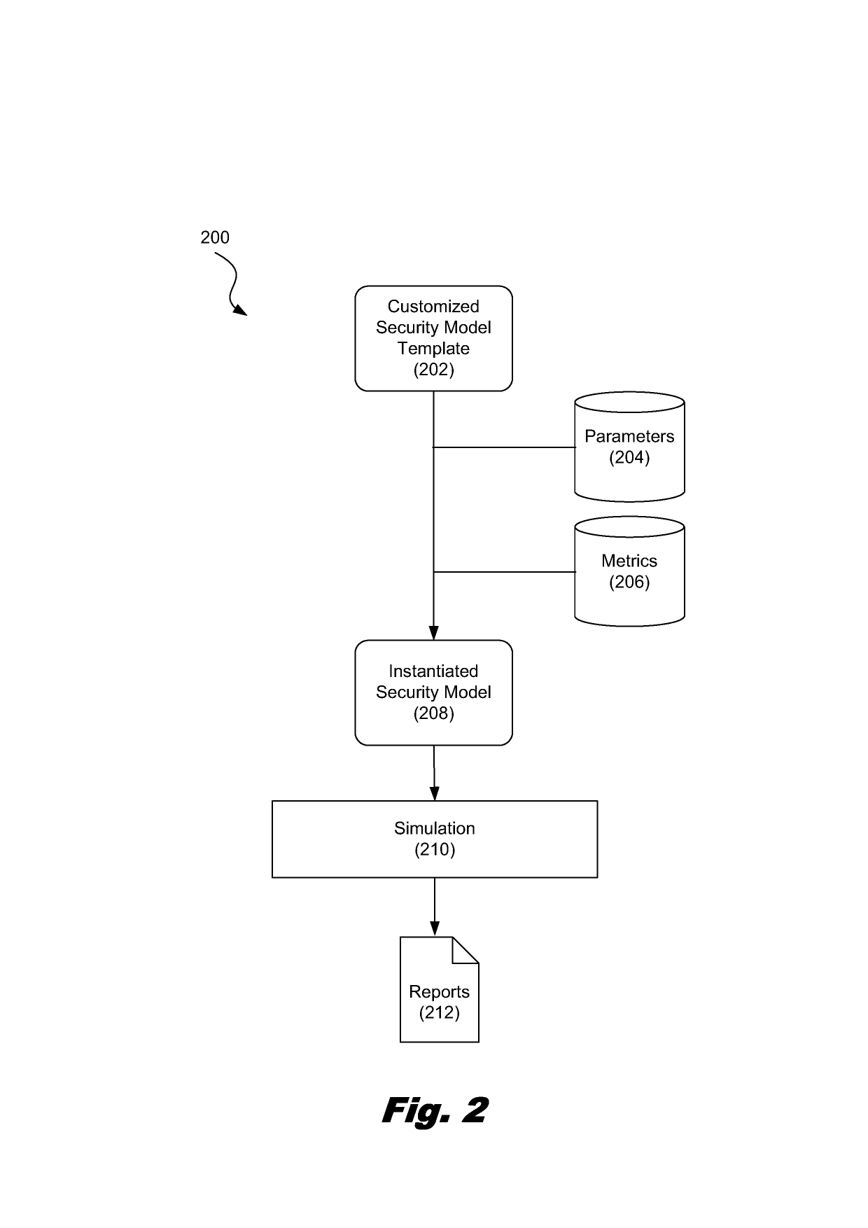

FIG. 2 is a diagram showing an illustrative process (200) for analyzing computing system security policies and procedures. Computing system security refers to any Information Technology (IT), networking, and other computing related system security. The process of analyzing such policies and procedures is performed by a physical computing system. Security policies and procedures refer to any policy or procedure that have an effect on security in which an organization engages. Such security policies may also affect other areas of the organization such as various business objectives. Moreover, various business decisions will also affect the security of an organization and can thus be included as security policies for use of methods and systems embodying principles described herein.

For example, a security policy may be to monitor all incoming emails for specific types of attachments that may be potentially harmful. Each email that includes a suspicious attachment may be flagged for review by security team personnel. An organization may have further policies for reviewing such emails using specific procedures such as opening the attachment in a testing environment to determine whether the attachment is safe. In a further example, a security policy may be to alert security personnel anytime particular server systems are accessed. The security personnel can then undergo procedures to ensure that the access was authorized. Such policies consume resources and may affect the overall security of an organization in certain ways.

According to certain illustrative examples, a customized security model template (202) is created based on a general security model template. The customized security model template (202) is customized to a specific organization's security related procedures. Security related procedures refer to any processes, actions, policies, or events that have an effect on the security of an organization.

For example, a customized security model template (202) may include an explicit representation of an organization's incident management and remediation processes. Incident management refers to the process of handling a breach in security. For example, if a computer virus affects an organization's computer network, then the incident management process refers to the process of stopping that virus and purging the computing systems. A remediation process refers to the process of repairing any damage, or remedying the adverse affects of a security breach. In the example of a computer virus, the remediation process refers to the process of fixing any damage caused by the virus. This may involve installing new hardware or software.

The customized security model template (202) also includes relevant resources of that organization by defining those resources using executable, probabilistic, discrete-event process models. Such models are executable because they can be used in simulations. These models are probabilistic because they use probability based functions. Furthermore, these models are “process-driven” based on specific events.

Models may be defined as representations of processes that include probabilistic state changes in response to events. Models used by methods and systems described herein may include representations of security processes, business processes (which may be impacted by or related to security processes), people processes such as the process undertaken by a security personnel team to gather additional information relating to a threat.

There are a wide variety of such modeling approaches that can be used including, but not limited to, flowcharts, finite state machines, discrete event models, and system models. In one example, a model is a graph including edges and nodes. All edges may be directed, meaning that the graph is asymmetrical. The nodes may be either decision nodes or process nodes. A decision node branches to one of two other nodes, but does not indicate a passage of time. Whether the node branches to one output or another depends on an underlying probability distribution associated with that node. A process node consumes some amount of time, which also depends on an underlying probability distribution of that node.

The customized security model template (202) includes several aspects of the organization to which it is customized. Specifically, the customized security model may represent the core processes for incident management and remediation. As will be described in more detail below, such processes may include alert assessment, additional information retrieval, identification of false positives, classification of incidents, and specific remediation steps. The customized security model template (202) may also represent the criteria used by an organization to determine false positives or to classify certain types of alerts.

The customized security model template (202) is then instantiated to form an instantiated security model (208) based on a set of parameters (204) such as empirical data collected from the organization. This empirical data may include a time distribution curve of the duration of particular security processes, the frequency of certain security alerts or events, and the likelihood of false positives. The empirical data may also be supplemented with manual assumptions and other estimates where appropriate. The instantiated security model (208) may also define specific metrics (206) which may be useful to decision makers. The customized security model template (202) may already define some basic metrics. However, the instantiated security model (208) may further customize the metrics (206) for specific purposes. For example, a particular metric (206) may be a time distribution for remediating particular types of security incidents. An additional metric (206) may be the amount of time spent on handling false positives.

In some examples, instantiating a customized security model template (202) may involve certain changes in the underlying structure of the customized security model template (202). For example, a different instantiation may be used to determine if a change in policy or procedure, as defined by the customized security model template (202), will be beneficial. Using the example in which a model is defined as a graph, an instantiation may alter some of the edges or nodes.

In some cases, the customized security model template (202) may define unbound parameters. An unbound parameter is one in which no specific value has been assigned. For example, an unbound parameter within the customized security model template (202) may define a distribution between x and y. During the instantiation process, specific values will be assigned to x and y. In some cases, the customized security model template (202) may assign default values to x and y which can be overridden during the instantiation process.

The various parameters (204) may include, time spent on a particular task, probability of specific events occurring, and availability of resources such as personnel at specific times. These listed parameters are not intended to be an exhaustive list of parameters which may be used in an instantiated security model. A variety of different parameters that define characteristics of an organization or the likelihood of certain events may be used in accordance with principles described herein.

The instantiated security model (208) is then used in a simulation process (210) to provide decision makers with reports (212) based on the indicated metrics and the empirical data. These reports (212) will provide the decision makers with important information to be used when making decisions for changes in security team operations. The simulation methods used may be based on probabilistic modeling. The precise manner in which the simulation process is performed is beyond the scope of the present application.

The reports (212) may show the results of the simulation with varying parameters. For example, various parameters to the security processes may be simulated so that security decision makers can determine how changes in such parameters will affect the security operations. Additionally, various assumptions and estimates may be varied according to possible changes so that the reports can indicate how such assumptions affect security operations. Specifically, certain “what-if” scenarios may be modeled based on changing environments or different parameters as provided by the security team.

A number of different what-if simulations may be run by varying certain parameters of the customized security model template (202). For example, the parameters of alert arrival or processing rates may be altered. The variation may also include the automation or elimination of certain remediation steps such as requiring management approval for certain actions. Different what-if simulations may run to determine how current procedures would hold up if circumstances such as number of security threats received increased. This would allow the security team to determine how prepared they are to handle particular scenarios which may occur. Particularly, it can be determined how resilient the current security processes are to a changing environment.

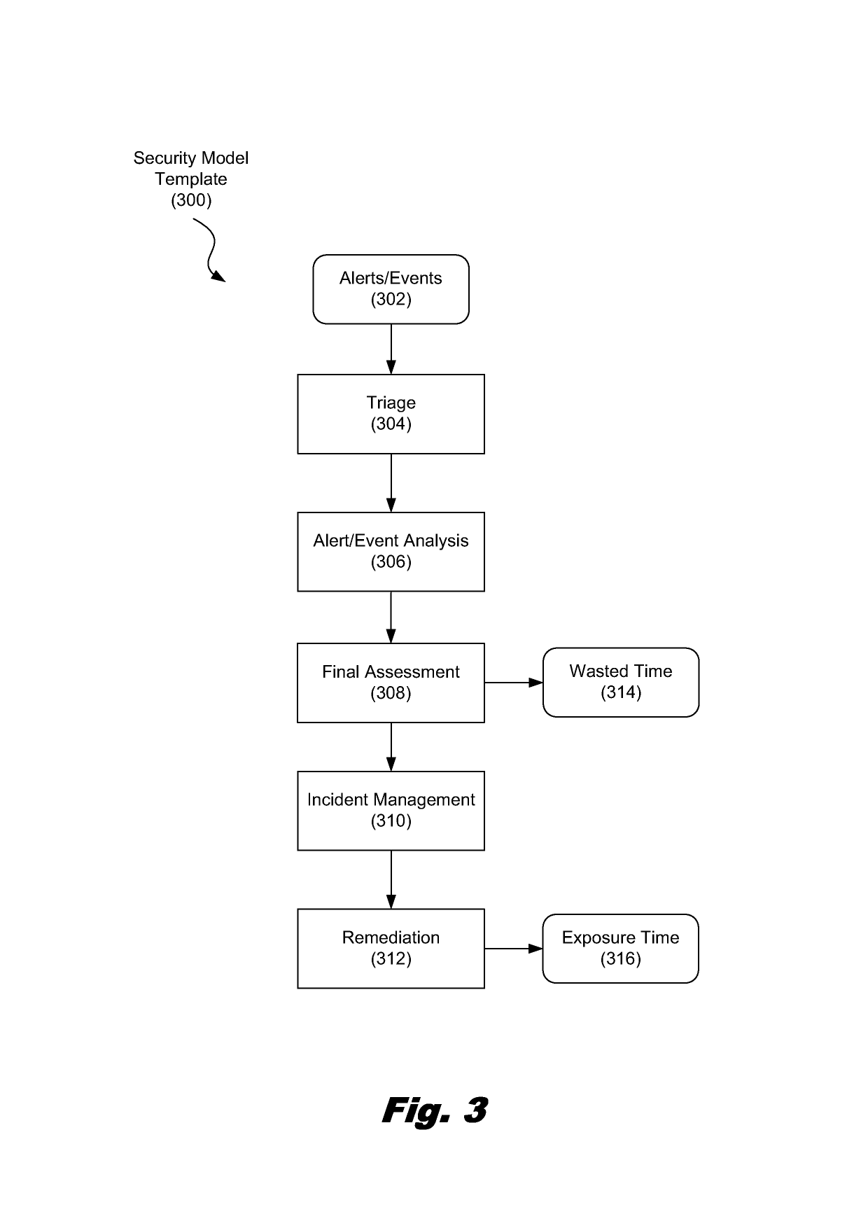

FIG. 3 is a diagram showing an illustrative general security model template (300). According to certain illustrative examples, the general security model template includes an alerts block (302), a triage block (304), an alert analysis block (306), a final assessment block (308), an incident management block (310), and a remediation block (312). The general security model template also defines certain outcomes such as time wasted (314) on false positives and exposure time (316).

The alert/event block (302) represents the process of collecting various alerts and event notifications. Many security personnel work in a Security Operation Center (SOC). The SOC team often uses a security tool referred to as a Security Information and Event Management (SIEM) system. The SIEM system will typically monitor an information security system or other asset and flag certain events for review by a security team. For example, the SIEM system may monitor emails and look for certain types of attachments or links which may be malicious. In case such an email is found, the SIEM system will form an alert for the security team. Other sources may provide alerts to the security personnel for review as well.

An event refers to a change in the state of something. For example, certain metrics may be used to describe the status of a network. One example is a metric that measures the current level of traffic on the network. When this value changes, an event notification may be sent to systems set up to receive such event notifications. For example, the SOC may have systems set up to receive event notifications. An alert refers to a specific event which the SOC is set up to monitor. For example, specific alerts that are triggered by certain events may be based on an expert SOC operator's experience regarding various information which may have been gathered during specific event analysis and management processes.

The triage block (304) represents the initial analysis performed by the security team to determine the seriousness of such alerts. Some alerts may be readily disposed of as non-threats. Other alerts may be categorized based on the possible threats they pose. The events may further be classified based on which alerts relate to known incidents and which alerts relate to unknown incidents. Events which pass the triage stage move on for deeper analysis.

The alert/event analysis (306) block represents the process of gaining more information for an alert event that has passed the triage stage. An alert or event notification that has passed the triage stage means that it is believed to pose a particular threat to the organization. The additional information may include information from the Information Technology (IT) department, various business departments, or external service providers. This additional information may help the security team determine the seriousness of the perceived threats.

The final assessment block (308) indicates the policies and procedures for making a final assessment of a threat. It may be the case that some of the alerts that passed the triage stage turn out to be false positives or not a serious threat based on the additional information collected. Thus, these threats may be disposed of. However, the alerts or event notifications which are believed to be serious threats to the organization will continue on to the next block. The time spent on the number of alerts that were disposed of as false positives or non-serious threats can be added to form a wasted time (314) metric.

The incident management block (310) represents the policies and procedures for managing the incident resulting from the perceived threat. For example, the security team may have to coordinate with personnel from other departments to take certain steps to protect various assets of the organization from the threat. The incident management block (310) defines the process for removing the threat as well.

The remediation block (312) represents the policies and procedures for remedying any damage done by the threat. The remediation process may also include policies for making changes to security procedures to prevent the perceived threat from occurring in the future. For example, the procedures for sorting alerts and event notifications may be modified to classify a particular threat as a higher risk to security than that risk was previously believes to be. The information collected from the remediation block may also define certain metrics such as the exposure time (316). The exposure time (306) indicates the amount of time the organization was vulnerable due to a security threat.

The policies and procedures described in the general security model template are to illustrate an example of a general security model template from which a customized security model template embodying principles described herein is formed. Other general models may be used as well. The following provides a few examples of how certain general security model template blocks may be customized to a particular organization.

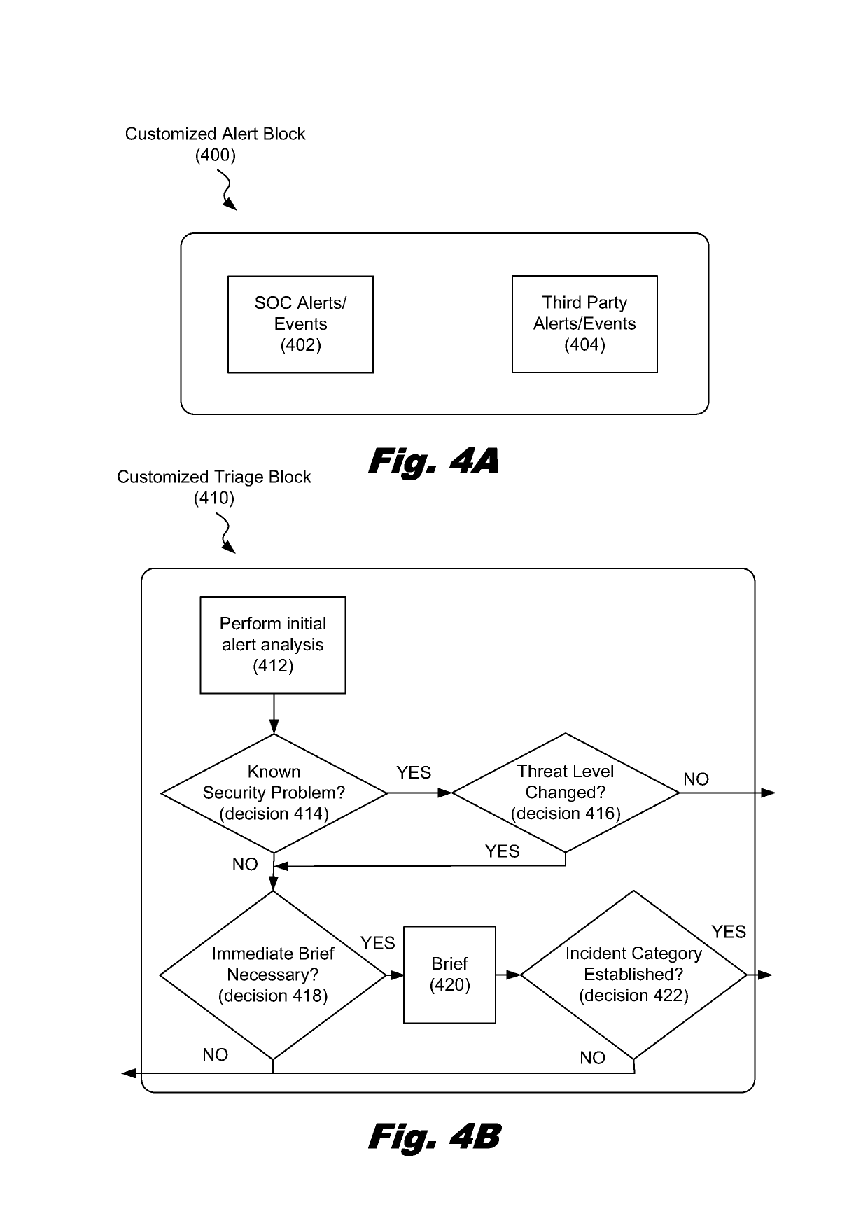

FIG. 4A is a diagram showing an illustrative customized alert block (402) of a customized security model template. According to certain illustrative examples, the alert block indicates that the organization's alert procedures include receiving alerts or event notifications from two classifications of sources. The first source is standard SOC alerts (402) as received from the organization's SIEM system. The second source for alerts or event notifications is third party alerts (404). Third party alerts or event notifications may be received from sources other than within the organization. Additionally, third party alerts may indicate how a virus, worm or other malicious piece of software has affected a third party's system. Such an alert may provide information that is useful for an organization to take steps to prevent an attack from the same or similar malicious piece of software.

FIG. 4B is a diagram showing an illustrative customized triage block (410) of a customized security model template. According to certain illustrative examples, the SOC team performs (block 412) an initial analysis of an alert received from an alert source. It is then determined (decision 414) whether the alert relates to a known security problem. If the alert does indeed (decision 414, YES) relate to a known security problem, then it is next determined (decision 416) whether the threat level has changed. If the threat level has not changed (decision 416, NO), then the process moves to a point outside the customized triage block (410).

If the alert does not (decision 414, NO) relate to a known security problem, or if the threat level has changed (decision 416, YES), then the process moves on to determine (decision 418) whether an immediate need to brief management is necessary. If there is no (decision 418, NO) immediate need to brief management, then the process moves to a point outside the customized triage block (410). However, if there is (decision 418, YES) an immediate need to brief management then that briefing process (block 420) begins.

After the briefing process (block 420), it is then determined (decision 422) whether an incident category should be established. Whether an incident category should (decision 422, YES) or should not (decision 422, NO) be established, the process will continue to a point outside the customized triage block (410) based on that determination.

As mentioned above, a customized security model template is instantiated with parameters such as empirical data and other assumptions and estimates. The examples of customized security model template blocks illustrated in FIGS. 4A and 4B, when instantiated may include specific information relating to various parameters of the security team operations. For example, the instantiation may add information such as the average number of alerts received in a day. The instantiation may also add information such as the likelihood that a particular alert represents a known security problem. The following gives an example of instantiating a block of a customized security model template.

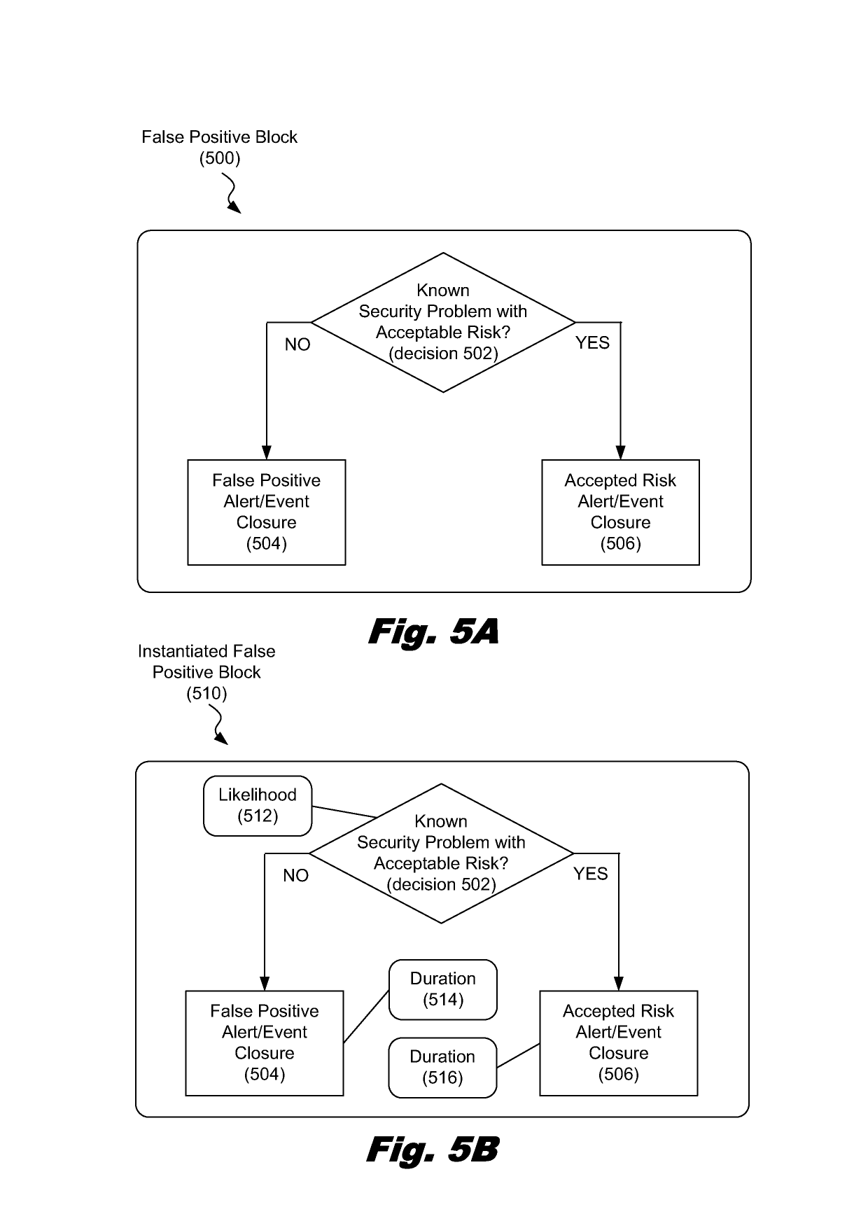

FIG. 5A is a diagram showing an illustrative false positive block (500) of a customized security model template. According to certain illustrative examples, the false positive block (500) begins the process by determining (decision 502) whether a received alert, which has passed the triage block (e.g. 410, FIG. 4B) by determining that it is a known security problem, is an acceptable risk or a false positive. If it is determined (decision 502, NO) that the alert is a false positive, then a false positive event/alert closure process (504) is initiated. Alternatively, if it is determined (decision 502, YES) that the alert is an acceptable risk, then an accepted risk alert/event closure process (506) is initiated. The closure processes may be different for each case.

FIG. 5B is a diagram showing an illustrative instantiated false positive block (510) of a customized security model template. Thus, the instantiated false positive block (510) is part of the instantiated security model. According to certain illustrative examples, each element within the false positive block is assigned a parameter during substantiation. For example, the determination block (502) is assigned a likelihood value (512). It may be the case that 25% of the time, an alert is determined to be a false positive and 75% of the time it is determined that the alert is an accepted risk.

Additionally, each of the closure blocks is assigned a duration value (514, 516). The duration value (514, 516) indicates the time it takes to complete the closure process. The duration value may be expressed in a variety of manners including, but not limited to, average time duration, a time range, and a time distribution. By instantiating each element within the customized security model template, the model is fit with parameters such as empirical data and various assumptions. The parameters may be designed to match current characteristics of an organization's security process or the parameters may be a set of hypothetical parameters of the organization's security process used to see how certain changes may affect the security team's efficiency.

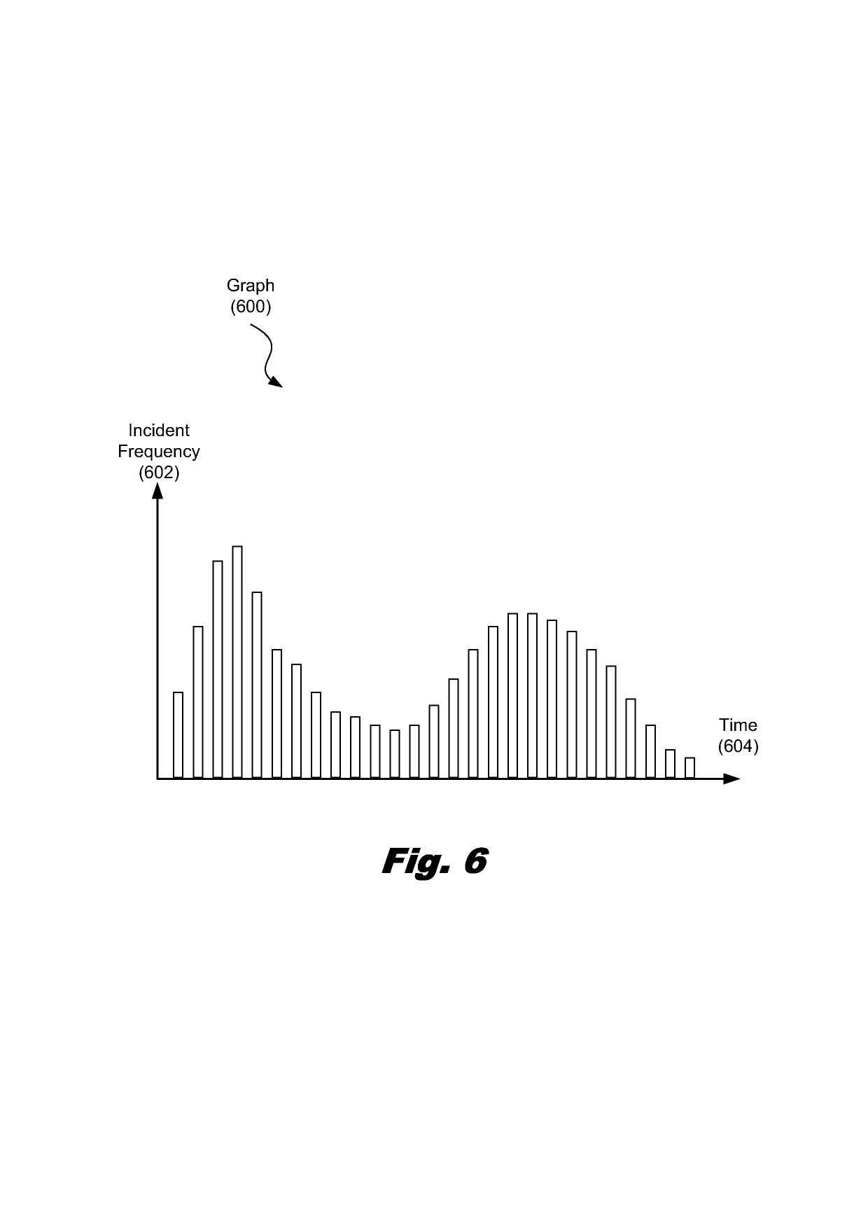

FIG. 6 is a diagram showing an illustrative graph (600) resulting from simulations run from an instantiated security model. According to certain illustrative examples, the horizontal axis represents time (604). The time may be expressed in days. The vertical axis represents incident frequency (602). This may be expressed as a percentage value. Thus, for each day along the horizontal axis, the graph indicates the percentage of incidents which take that many days to resolve. Such a metric may be defined during the instantiation phase of a process embodying principles described herein. The graph (602) provides a decision maker with a visual indication of characteristics of the security process which are relevant to his or her decision making.

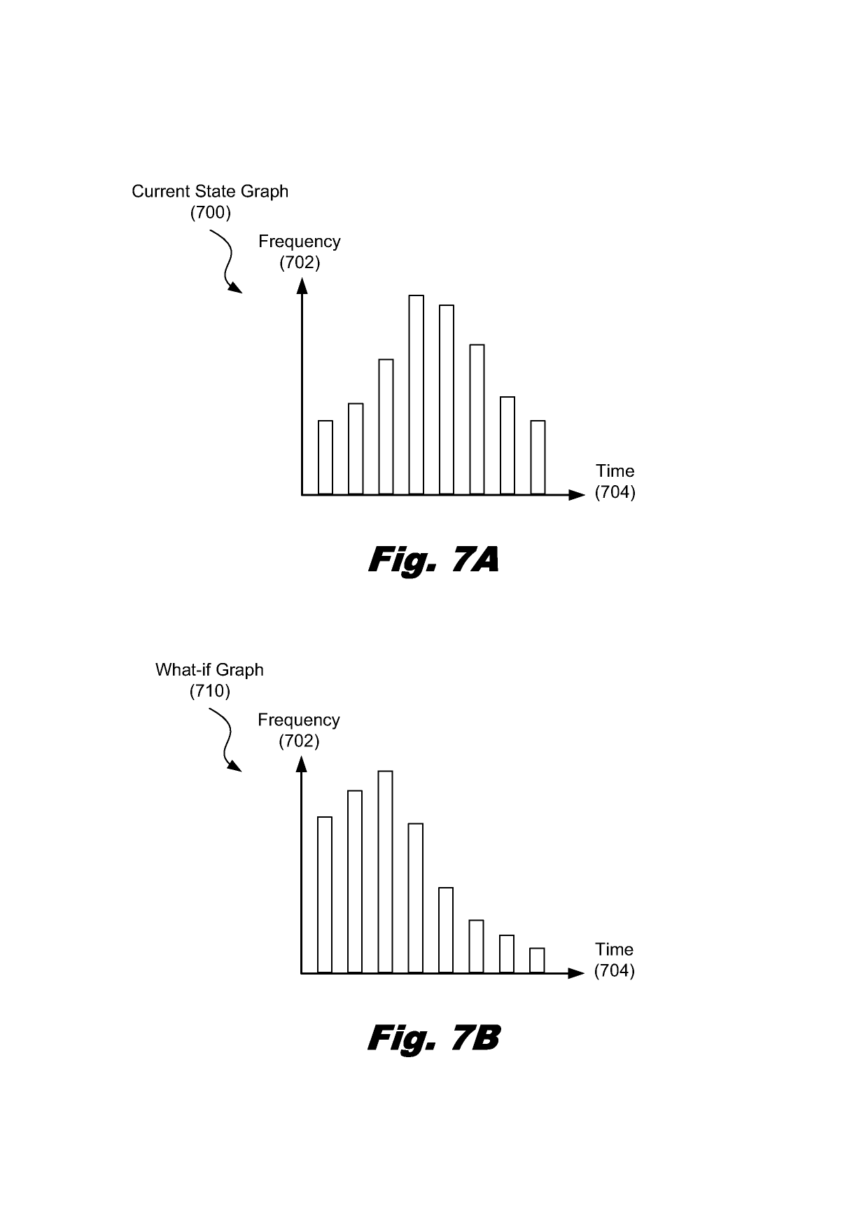

FIGS. 7A and 7B are graphs showing results of simulations run from an instantiated security model with varying parameters. FIG. 7A is a graph (700) depicting the frequency of time spent on false positives. The horizontal axis represents time (704) while the vertical axis represents the frequency of incidents (702) at a particular time value. Such a graph provides a decision maker of a visual depiction of the effectiveness of the policies which affect time spent handling false positives. It may be the case that the decision maker wishes to see how certain changes in policy, changes in assumptions, or changes in projected events will affect such a graph.

FIG. 7B is a diagram of a graph (710) showing the result of changes to certain parameters. As can be seen, a greater percentage of false positive handling is done in less time. This represents an overall change for better as it is desirable to minimize time spent handling false positives. Analysis of such a change in parameters allows the decision maker to determine that certain changes in policy will yield beneficial results.

For example, a decision maker may wish to determine how increasing the number of security personnel would affect the rate at which certain events are analyzed. Various parameters that are affected by the number of security personnel may be changed for a different instantiation of the customized security model template. The instantiated security model may then be simulated and the various metrics displayed in the reports. Such reports may help the decision maker to determine whether the benefit of adding another security team member is worth the cost.

In a further example, a decision maker may wish to determine how an underlying change in the structure of the model will affect the results of the simulation. Specifically, the decision maker may wish to determine whether the step of briefing management about specific events affects the efficiency of the security incident management process. The piece of the model that indicates this step may be removed from the customized security model template for a specific instantiation. The instantiated security model may then be simulated and the results displayed in the reports. This may allow the decision maker to determine whether a change in security policy will be beneficial or not.

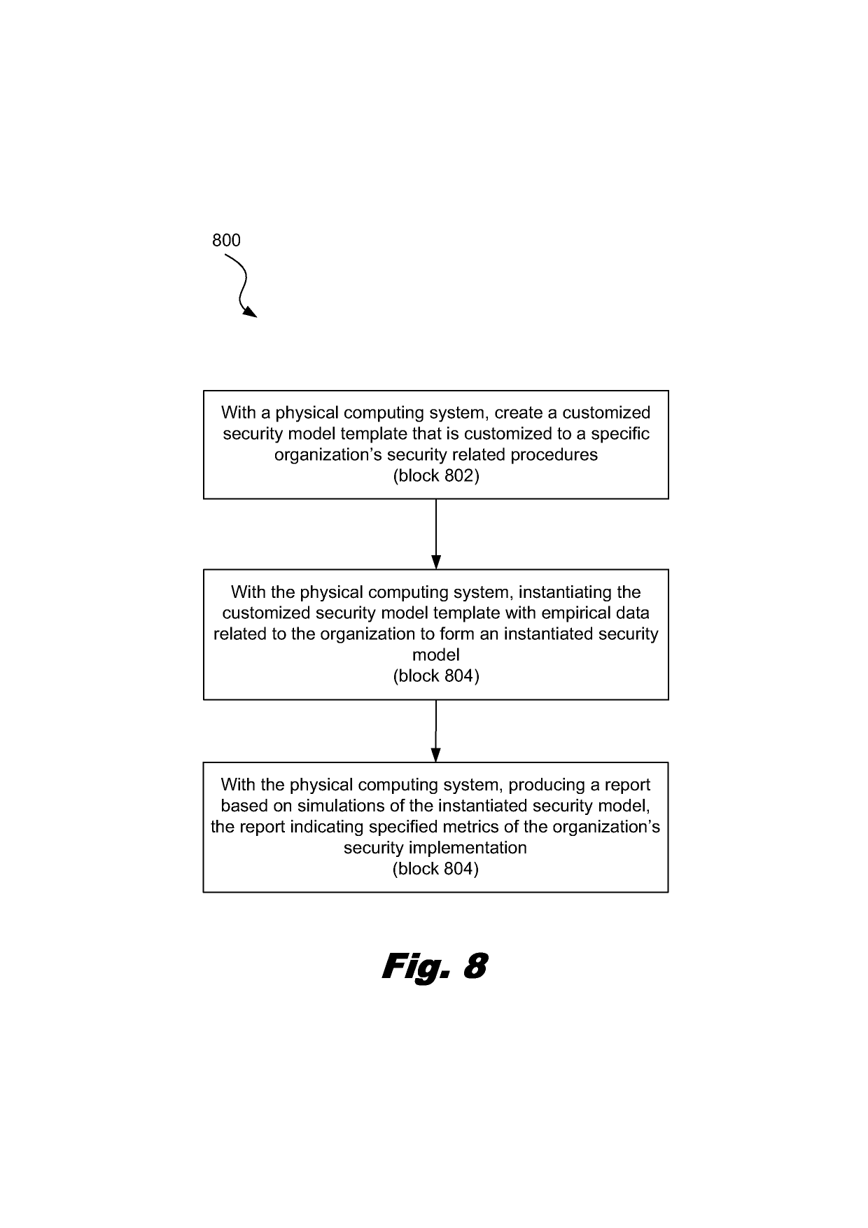

FIG. 8 is a flowchart showing an illustrative method for analyzing security policies and procedures. According to certain illustrative examples, the method includes, with a physical computing system, creating (block 802) a customized security model template from a security model template, the customized security model template being customized for a specific organization's security related procedures. The method further includes instantiating (block 804) the customized security model template with empirical data related to the organization, and producing (block 806) a report based on simulations of the instantiated security model, the report indicating specified metrics of the organization's security implementation.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method comprising:
with a physical computing system, creating a customized security model template that is customized to a specific organization's computing system security related procedures;
with said physical computing system, instantiating said customized security model template with parameters related to said organization to form an instantiated security model; and
with said physical computing system, producing a report based on simulations of said instantiated security model, said report indicating specified metrics of said organization's security implementation.

2. The method of claim 1, wherein said customized security model template comprises event collection processes, event analysis and triage processes, collection of additional event data processes, sorting false positives processes, incident management processes, and remediation processes.

3. The method of claim 1, wherein said parameters comprise at least one of: empirical data and assumptions.

4. The method of claim 3, wherein said empirical data comprises historical data relating to at least one of: time spent on specific tasks, and probability of specific events occurring.

5. The method of claim 3, wherein said assumptions comprise at least one of: estimations based on domain expertise, and hypothetical data.

6. The method of claim 1, wherein said reports comprise at least one of:
time spent on false positives, and time spent on incident management.

7. The method of claim 1, wherein said report comprises comparisons made between simulations of different instantiations of said customized security model template, said different instantiations using a different set of parameters.

8. A computing system comprising:
at least one processor;
a memory communicatively coupled to the at least one processor, the memory comprising computer executable code that, when executed by the at least one processor, causes the at least one processor to:
create a customized security model template that is customized for a specific organization's computing system security related procedures;
instantiate said customized security model template with a set of parameters to create an instantiated security model; and
produce a report based on simulations of said instantiated security model, said report indicating specified metrics of said organization's security implementation.

9. The system of claim 8, wherein said customized security model template comprises event collection processes, event analysis and triage processes, collection of additional event data processes, sorting false positives processes, incident management processes, and remediation processes.

10. The system of claim 8, wherein said parameters comprise at least one of: empirical data and assumptions.

11. The system of claim 10, wherein said empirical data comprises historical data relating to at least one of: time spent on specific tasks, and probability of specific events occurring.

12. The system of claim 10, wherein said assumptions comprise at least one of: estimations based on domain expertise, and hypothetical data.

13. The system of claim 8, wherein said report comprises at least one of:
time spent on false positives, time spent on incident management.

14. The system of claim 8, wherein said report comprises comparisons made between simulations of different instantiations of said customized security model template, said different instantiations using a different set of parameters.

15. A method comprising:
with a physical computing system, creating a customized security model template that is customized for a specific organization's incident management and remediation related computing system security procedures;
with said physical computing system, creating a number of instantiations of said customized security model template, each of said instantiations using a different set of parameters related to said organization; and
with said physical computing system, producing a number of reports based on simulations of said instantiations, said reports indicating specified metrics of said organization's security implementation.
